(19) United States
(12) Patent Application Publication
(10) Pub. No.: US 2004/0184462 A1
(43) Pub. Date: Sep. 23, 2004

(54) Sliding window implementation for regulating packets for protocol-based connections

(75) Inventors: Rajesh Narayanan, Santa Clara, CA (US); Aaron Williams, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Network Equipment Technologies, Fremont, CA

(21) Appl. No.: 10/646,617

(22) Filed: Aug. 21, 2003

Related U.S. Application Data
(60) Provisional application No. 60/455,730, filed on Mar. 17, 2003.

(51) Int. Cl. H04L 12/56

(52) U.S. Cl. 370/395.21; 370/230

(57) ABSTRACT

A method is presented for managing packets in a network comprising receiving a packet associated with a request for a protocol-based connection, assigning the packet to a selected one of a plurality of classes, forwarding the packet if number of packets forwarded from the selected class in a predetermined time interval has not reached a first maximum count, and dropping the packet if number of packets forwarded from the class in the predetermined time interval has reached the first maximum count. In one embodiment, the packet is forwarded only if a count of active connection requests has not reached a second maximum limit. The method may further comprise steps of, after forwarding the packet, receiving an additional packet associated with the requested protocol-based connection, assigning the additional packet to a pass-through class, and forwarding the additional packet even if the first maximum count or the second maximum count has been reached.

### CROSS-REFERENCES TO RELATED APPLICATIONS

This application claims priority from U.S. Provisional Application No. 60/455,730, filed Mar. 17, 2003. The 60/455,730 application is incorporated herein by reference.

### BACKGROUND OF THE INVENTION

A common problem faced by a system required to handle multiple protocol-based connections, such as Point-to-Point Protocol (PPP) connections, is the likelihood of simultaneous attempts by numerous sources to establish connections. The operations involved in establishing each connection likely requires the system to commit additional resources such as processing and storage capacity. When numerous sources demand connections at the same time, the system may face the danger of over-extending its capabilities. Even if the system is able to maintain numerous connections, it may not be able to effectively handle attempts to establish all those connection within a relatively short period of time. Indeed, the system may not be able to gracefully handle such peaks in demand for its resources without compromising on stability, reliability and/or performance. For example, this effect is often exhibited in a distributed denial of service (DDOS) attack, whereby a system is inundated with unexpectedly large amounts of network control traffic, to the point of tying up or breaking down normal services provided by the system.

Known methods directed toward this difficult problem include the addition of processors or memory space in the system and the implementation of filters through software. Even with added processors and memory, however, system resources are still finite in nature. Higher peaks in demand resulting from a larger number of connection attempts may still trigger similar complications. Thus, simply adding more capacity may not resolve the problem, especially if the number of simultaneous connection attempts has the potential to reaching unwieldy levels. As to the implementation of software filters, an operation performed by such filters to carefully examine each session and sift out sessions for certain connections may itself represent a processing-intensive task. Thus, complicated software filters may not provide an efficient solution and can even contribute to the degradation of an already over-extended system.

Further, the system may not be able to rely on the capabilities communication protocols to resolve this problem. First, the system may be involved with operation of a number of different communication protocols. Different protocols vary greatly in their design and capabilities. Reliance on the varied capabilities of different protocols would necessarily involve disparate and/or inadequate protocol-dependent approaches. Second, methods relying on individual protocols may require adjustments to the protocols themselves. Such adjustments can lead to serious compatibility issues by creating different versions of a given protocol. Regulation of protocol-based connections that does not rely on capabilities of specific communication protocols is likely to be far more robust and effective.

Thus, current approaches exhibit significant shortcomings in managing the establishment of multiple protocol-based connections to a system.

### BRIEF SUMMARY OF THE INVENTION

The present invention relates to a method for managing packets in a network comprising the steps of receiving a packet associated with a request for a protocol-based connection, assigning the packet to a selected one of a plurality of classes, forwarding the packet if number of packets forwarded from the selected class in a predetermined time interval has not reached a first maximum count, and dropping the packet if number of packets forwarded from the class in the predetermined time interval has reached the first maximum count. The first maximum count and/or the predetermined time interval may be adjustable to effectuate different rates of packet forwarding for the selected class. A counter associated with the selected class may be used to determine whether number of packets forwarded from the selected class in the predetermined time interval has reached the first maximum count, and the counter may be a count-down counter.

In one embodiment, the packet is forwarded only if a count of active connection requests has not reached a second maximum limit. The count of active connection requests is incremented when a packet associated with a request for a protocol-based connection is forwarded from the selected class. The count of active connection requests is decremented when a protocol-based connection is established, or when a protocol-based connection is terminated before being established.

The method may further comprise steps of, after forwarding the packet, receiving an additional packet associated with the requested protocol-based connection, assigning the additional packet to a pass-through class, and forwarding the additional packet even if the first maximum count or the second maximum count has been reached. The additional packet may relate to status of the requested protocol-based connection. It may also relate to termination of the requested protocol-based connection.

### BRIEF DESCRIPTION OF THE DRAWINGS

FIG. 1 depicts an illustrative system for regulating protocol-based connections in accordance with one embodiment of the present invention.

FIG. 2 illustrate an example of how packets of a particular class are forwarded and dropped using a counter, highlighting packets of a particular class before they are forwarded or dropped.

FIG. 3 more clearly shows which packets from FIG. 2 are to be forwarded.

FIG. 4 more clearly shows which packets from FIG. 2 are to be dropped.

FIG. 5 is a flow chart outlining a process for systematically forwarding a packet associated with a request for a PPP connection, in accordance with one embodiment of the present invention.

### DETAILED DESCRIPTION OF THE INVENTION

Regulation of Protocol-Based Connections

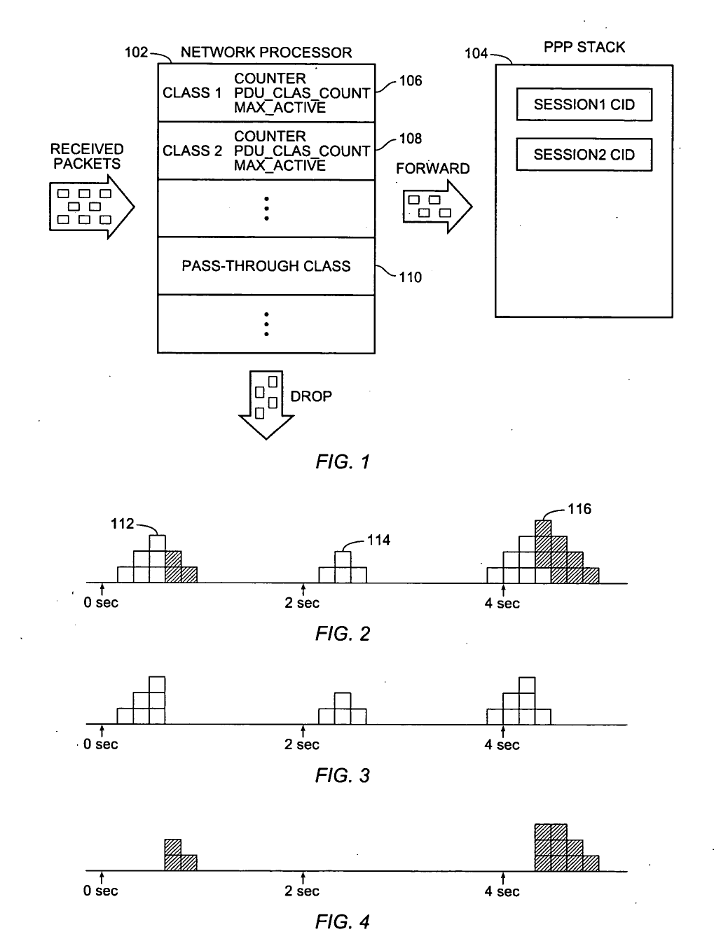

FIG. 1 depicts an illustrative system 100 for regulating protocol-based connections in accordance with one embodiment of the present invention. The system 100 may be implemented in a remote access server, or some other network equipment, that handles protocol-based connections from numerous sources. The system 100 may handle protocol-based connections involving a number of different protocols. These protocols may include Point-to-Point Protocol (PPP), Point-to-Point Protocol over Ethernet (PPPoE), Layer Two Tunneling Protocol (L2TP), Dynamic Host Configuration Protocol (DHCP), Transmission Control Protocol (TCP), and others. The system 100 may handle more than one protocol at a given time, and such protocols may operate at different layers of network communication. Just as an example, FIG. 1 illustrates system 100 as utilizing a Point-to-Point Protocol (PPP).

The system 100 includes a network processor 102 communicatively coupled to a PPP stack 104. The network processor 102 may be a part of a data plane implemented in a remote access server, and the PPP stack 104 may be established in an associated control plane implemented in the same remote access server. Alternatively, The data plane and control plane may also be implemented as equipment distributed to multiple locations. The data plane and the control plane may include a combination of hardware and software, such as different processors, application-specific integrated circuits (ASICs), programmable devices, logic circuits, and various types of software code.

The network processor 102 receives a large number of packets, including request packets from different sources requesting protocol-based connection. For example, some of these request packets may be PPP-CONFIG-REQ packets from PPP clients attempting to establish PPP connections with the system 100. Here, the term “packet” refers generally to a portion of digital information. While it is not necessary, a packet may include a header and a payload, which can contain another packet. Thus, a packet may comprise data arranged in a nested fashion. The packets may represent various types of data associated with different protocols, at different levels communication, and possibly for different networking systems.

According to the present embodiment of the invention, the network processor 102 regulates the number of active sessions processed at the PPP stack 104 for establishing PPP connections by systematically forwarding some of the PPP-CONFIG-REQ packets to the PPP stack 104 and dropping others of the PPP-CONFIG-REQ packets. Dropped packets may be discarded permanently or processed in some alternative fashion, such as being stored for later processing or studied statistically.

Request packets for each communication protocol may be assigned to a particular class, such as classes 106 and 108. For instance, PPP-CONFIG-REQ packets may be assigned to class 106. Request packets for another protocol may be assigned to a different class. Other arrangements by which classes are used to treat particular packets as a group are also possible. Systematic forwarding and dropping of packets is achieved on a class-by-class basis, by limiting the number of packets forwarded from each class to a maximum count for each predetermined time interval. The packet forwarding rate for each class can be controlled by adjusting the maximum count associated with the class, the predetermined time interval associated with the class, or both.

For example, PPP control packets may be classified into the class 106 with the maximum count (PDU_CLAS_COUNT) set to 10 and the predetermined time interval set to 1 second for the class 106. This means that only 10 PPP control packets per second will be forwarded from the network processor 102 to the PPP stack 104. If 1000 PPP clients try to connect to the remote access server at the same time, all 1000 PPP clients will simultaneously generate PPP-CONFIG-REQ packets. Of these only 10 will be forwarded in the very first second, while the remaining 990 will be dropped by the network processor 102. Each of the 10 PPP-CONFIG-REQ packets that manage to pass through the network processor will be delivered to the PPP stack 104 along with an appropriate connection identifier (CID).

At the PPP stack 104, establishment of the connections associated with the 10 forwarded PPP-CONFIG-REQ packets may take some time. In fact, each of the 10 PPP connection requests remain “active” until the connection is established, or until the connection is prematurely terminated before being established. In other words, there may be 10 active sessions of PPP connection requests at this point. Continuing with the example, after the first 10 PPP-CONFIG-REQ packets are forwarded in the first second, another group of 10 PPP-CONFIG-REQ packets may be forwarded in the next second. If none of the connections has had sufficient time to be established, and none has been prematurely terminated, there would be 20 active PPP connection requests being processed at the PPP stack 104. The number of active connection requests could quickly build up in this manner.

Another limit placed the forwarding of packets in system 100 may be used to control such build-up. A MAX_ACTIVE parameter can place an upper limit on the number of active connection requests the PPP stack 104 will be required to process. Here, MAX_ACTIVE may be set to 50. Again continuing with the previous example, if the PPP stack 104 receives connection requests at a rate of 10 per second, and the PPP stack 104 takes 6 seconds to establish each PPP connection request, then after 5 seconds the number of active PPP connection requests being processed at the PPP stack 104 would reach the threshold value of 50. The network processor 102 would then cease to forward any more PPP-CONTROL-REQ packets to the PPP stack 104. Such packets may be dropped. When a connection corresponding to a pending request is established, or if the connection is terminated prematurely before being established, the number of active PPP connection requests decrements. Thus, the number of active PPP connection request may drop back down below 50 (MAX_ACTIVE). In response, the network processor 102 would once again forward of PPP-CONTROL-REQ packets in the class-based, rate-controlled manner described previously.

According to one embodiment of the present invention, some packets associated with existing connection request may be forwarded using a pass-through class, even when other packets are being dropped. In the case of a PPP protocol, proper processing of an active PPP connection request may require forwarding of additional packets related to the requested connection. For example, a PPP-ECHO-REQ packet or a PPP-ECHO-RESP packet may facilitate the establishment of an active PPP connection request. A PPP-TERMINATE-REQ packet or a PPP-TERMINATE-ACK packet may facilitate the closure of an active PPP connection request. These packets may need to be forwarded to the PPP stack 104, even if the number of packets forwarded during a predetermined interval has reached the PDU_CLAS_COUNT or the number of active PPP connection requests has reached MAX_ACTIVE. To allow proper forwarding of these packets, a pass-through class may be used. Accordingly, the network processor 102 may assign each PPP control packet having a CID corresponding to an active PPP connection request to a pass-through class 110. Packets assigned to the pass-through class 110 are then automatically forwarded to the PPP stack 104 without the need to examine PDU_CLAS_COUNT or MAX_ACTIVE.

The system 100 can thus effectively regulate the forwarding of packets associated with requests for protocol-based connection. This is done by utilizing an efficient packet classification technique, without the need to modify the protocols themselves.

Implementation Using Counters

In one embodiment of the invention, a counter is used to limit the number of packets forwarded from each class to a maximum count for each predetermined time interval. Each class may be associated with a counter that keeps track of how many packets from the class have been forwarded since a previous reset of the counter. Once the counter reaches PDU_CLAS_COUNT, additional packets from that class are dropped, until the counter for the class is reset. The counter can be reset once for every predetermined time interval, to allow more packets from the class to be forwarded. Such periodic resets can be accomplished by use of a timer associated with the class. Alternatively, the counter can be reset by some other method. According to the present invention, these counters and timers may be implemented in hardware, software, a combination of hardware and software, or by some other means.

FIGS. 2 through 4 illustrate an example of how packets of a particular class are forwarded and dropped using a counter, in accordance with the present embodiment of the invention. Here, PDU_CLAS_COUNT is set to 6, and the predetermined time interval is set to 2 seconds. FIG. 2 shows some of the packets of this particular class, before they are forwarded or dropped. As shown, the packets make up three distinct groups 112, 114, and 116. The first group 112 contains a total of 9 packets and is processed after a reset of the counter at time=0 sec. Thus, the first 6 packets (unshaded) from group 112 can be forwarded. The remaining 3 packets (shaded) from group 112 are to be dropped. In fact, until the next reset of the counter, any additional packets of this class would also be dropped. The next reset of the counter occurs at time=2 sec. Group 114 contains a total of 4 packets and is processed after the reset of the counter at time=2 sec. Thus, all 4 packets (unshaded) from group 114 can be forwarded. The next reset of the counter occurs at time=4 sec. Group 116 contains a total of 16 packets and is processed, for the most part, after the reset of the counter at time=4 sec. However, the first packet of group 116 is actually processed prior to the reset of the counter at time=4 sec. Because only 4 packets have been counted since the previous reset of the counter at time=2 sec., there is room for 2 more packets to be forwarded, and thus the first packet (unshaded) of group 116 can be forwarded. At time=4 seconds, the counter is reset for 6 more packets to be forwarded. Thus, 6 packets (unshaded) of the remaining 15 packets from group 116 can be forwarded. The other 9 packets (shaded) of the remaining 15 packets from group 116 would be dropped. FIG. 3 more clearly shows which packets from FIG. 2 are to be forwarded, and FIG. 4 more clearly shows which packets from FIG. 2 are to be dropped. The number of packets and specific counter and timer values demonstrated in FIGS. 2-4 are chosen to provide a simple illustration. Different numbers and values are within the scope of the present invention.

In one embodiment, a count-down counter can be employed. For example, the count-down timer for a particular class may be initialized to PDU_CLAS_COUNT, which has a value of 6 in the previous example. Before forwarding each packet from this class, the current value of the count-down counter is checked. If the current value of the count-down counter is non-zero, the count-down timer is decremented by 1 and the packet in question is forwarded. If the current value of the count-down counter is zero, the packet in question is dropped. Thus, once the count-down timer reaches zero, additional packets from this class would be dropped until the count-down timer is reset to the PDU_CLAS_COUNT. Such resets would take place once for every predetermined time interval. Alternatively, a count-up counter, or some other type of counting mechanism, may be used.

Process Illustration

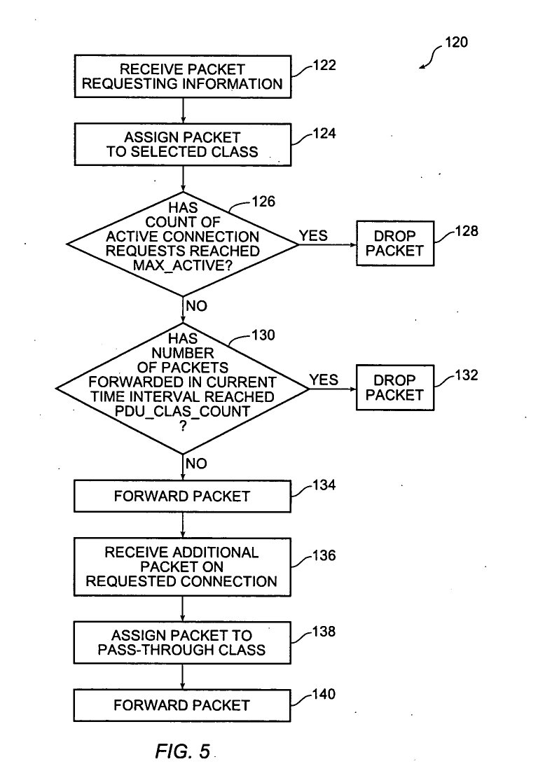

FIG. 5 is a flow chart outlining a process 120 for systematically forwarding a packet associated with a request for a PPP connection, in accordance with one embodiment of the present invention. At a step 122, a packet associated with a request for protocol-based connection is received at some designated receiver, such as the network processor 102 shown in FIG. 1. Here, the packet may be a PPP-CONFIG-REQ packet. At a step 124, the packet is assigned to a selected class. At step 126, it is determined whether a count of the number of active connection requests has reached a maximum limit, such as MAX_ACTIVE. If so, the packet is dropped at step 128. If not, at a step 130, it is determined whether the number of packets forwarded from the class in the current predetermined time interval has reached a maximum limit, such as PDU_CLAS_COUNT. If so, the packet is dropped at step 132. If not, the packet is forwarded at step 134.

At step 136, an additional packet associated with an active connection request is received. For example, the additional packet may relate to an active connection request initiated by the packet forwarded at step 134. Since the additional packet received at step 136 is associated with an active connection request, it is forwarded automatically without the processing illustrated in steps 124 through 134. Specifically, at step 138, the additional packet is assigned to a pass-through class. At step 140, the additional packet is forwarded.

Although the present invention has been described in terms of specific embodiments, it should be apparent to those skilled in the art that the scope of the present invention is not limited to the described specific embodiments. The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for managing connections in a network comprising:
receiving a packet associated with a request for a protocol-based connection;
assigning the packet to a selected one of a plurality of classes;
forwarding the packet if number of packets forwarded from the selected class in a predetermined time interval has not reached a first maximum count; and
dropping the packet if number of packets forwarded from the class in the predetermined time interval has reached the first maximum count.

2. The method of claim 1 wherein the first maximum count is adjustable to effectuate different rates of packet forwarding for the selected class.

3. The method of claim 1 wherein the predetermined time interval is adjustable to effectuate different rates of packet forwarding for the selected class.

4. The method of claim 1 wherein a counter associated with the selected class is used to determine whether number of packets forwarded from the selected class in the predetermined time interval has reached the first maximum count.

5. The method of claim 4 wherein the counter is a count-down counter.

6. The method of claim 1 wherein the packet is forwarded only if a count of active connection requests has not reached a second maximum limit.

7. The method of claim 6 wherein the count of active connection requests is incremented when a packet associated with a request for a protocol-based connection is forwarded from the selected class.

8. The method of claim 6 wherein the count of active connection requests is decremented when a protocol-based connection is established.

9. The method of claim 6 wherein the count of active connection requests is decremented when a protocol-based connection is terminated before being established.

10. The method of claim 1 further comprising:
after forwarding the packet, receiving an additional packet associated with the requested protocol-based connection;
assigning the additional packet to a pass-through class; and
forwarding the additional packet even if the first maximum count or the second maximum count has been reached.

11. The method of claim 10 wherein the additional packet relates to status of the requested protocol-based connection.

12. The method of claim 10 wherein the additional packet relates to termination of the requested protocol-based connection.

13. The method of claim 1 wherein the protocol-based connection is based on a Point-to-Point Protocol (PPP).

14. The method of claim 1 wherein the protocol-based connection is based on a Point-to-Point Protocol over Ethernet (PPPoE).

15. The method of claim 1 wherein the protocol-based connection is based on a Layer Two Tunneling Protocol (L2TP).

16. The method of claim 1 wherein the protocol-based connection is based on a Dynamic Host Configuration Protocol (DHCP).

17. An apparatus for managing connections in a network comprising:
a control plane operable to process requests for protocol-based connection; and
a data plane operable to receive a packet associated with a request for a protocol-based connection,
assign the packet to a selected one of a plurality of classes,
forward the packet to the control plane if number of packets forwarded from the selected class in a predetermined time interval has not reached a first maximum count, and
drop the packet if number of packets forwarded from the class in the predetermined time interval has reached the first maximum count.

18. The apparatus of claim 17 wherein the first maximum count is adjustable to effectuate different rates of packet forwarding for the selected class.

19. The apparatus of claim 17 wherein the predetermined time interval is adjustable to effectuate different rates of packet forwarding for the selected class.

20. The apparatus of claim 17 wherein a counter associated with the selected class is used to determine whether number of packets forwarded from the selected class in the predetermined time interval has reached the first maximum count.

21. The apparatus of claim 20 wherein the counter is a count-down counter.

22. The apparatus of claim 17 wherein the packet is forwarded only if a count of active connection requests has not reached a second maximum limit.

23. The apparatus of claim 22 wherein the count of active connection requests is incremented when a packet associated with a request for a protocol-based connection is forwarded from the selected class.

24. The apparatus of claim 22 wherein the count of active connection requests is decremented when a protocol-based connection is established.

25. The apparatus of claim 22 wherein the count of active connection requests is decremented when a protocol-based connection is terminated before being established.

26. The apparatus of claim 17 further comprising:
after forwarding the packet, receiving an additional packet associated with the requested protocol-based connection;
assigning the additional packet to a pass-through class; and
forwarding the additional packet even if the first maximum count or the second maximum count has been reached.

27. The apparatus of claim 26 wherein the additional packet relates to status of the requested protocol-based connection.

28. The apparatus of claim 26 wherein the additional packet relates to termination of the requested protocol-based connection.

29. The apparatus of claim 17 wherein the protocol-based connection is based on a Point-to-Point Protocol (PPP).

30. The apparatus of claim 17 wherein the protocol-based connection is based on a Point-to-Point Protocol over Ethernet (PPPoE).

31. The apparatus of claim 17 wherein the protocol-based connection is based on a Layer Two Tunneling Protocol (L2TP).

32. The apparatus of claim 17 wherein the protocol-based connection is based on a Dynamic Host Configuration Protocol (DHCP).

33. A system for managing connections in a network comprising:
means for receiving a packet associated with a request for a protocol-based connection;
means for assigning the packet to a selected one of a plurality of classes;
means for forwarding the packet if number of packets forwarded from the selected class in a predetermined time interval has not reached a first maximum count; and
means for dropping the packet if number of packets forwarded from the class in the predetermined time interval has reached the first maximum count.
